(19) United States
(12) Patent Application Publication
(10) Pub. No.: US 2017/0117524 A1
(43) Pub. Date: Apr. 27, 2017

(54) SEPARATOR AND ELECTRODE ASSEMBLY OF LITHIUM SECONDARY BATTERY

(71) Applicant: INDUSTRIAL TECHNOLOGY RESEARCH INSTITUTE, Hsinchu (TW)

(72) Inventors: Wan-Shu CHEN, Hsinchu City (TW); Chyi-Ming LEU, Jhudong Township (TW); Fang-Hsing HOU, Hsinchu City (TW); Yin-Ju YANG, Hsinchu City (TW); Tzu-Hsien HAN, Hsinchu City (TW)

(73) Assignee: INDUSTRIAL TECHNOLOGY RESEARCH INSTITUTE, Hsinchu (TW)

(21) Appl. No.: 14/958,475

(22) Filed: Dec. 3, 2015

(30) Foreign Application Priority Data
Oct. 26, 2015 (TW) 104135051

(51) Int. Cl. H01M 2/16; H01M 10/052

(52) U.S. Cl. CPC H01M 2/1686; H01M 10/052; H01M 2/1673; H01M 2/162

(57) ABSTRACT

A separator is provided, which includes a porous polyolefin layer and a nano fiber web thereon, wherein the nano fiber web includes a plurality of nano fibers interwoven with each other. The nano fiber includes polyimide polymerized of diamine and dianhydride, wherein at least one of the diamine and the dianhydride is aliphatic or cycloaliphatic.

### CROSS REFERENCE TO RELATED APPLICATIONS

This application claims priority of Taiwan Patent Application No. 104135051, filed on Oct. 26, 2015, the entirety of which is incorporated by reference herein.

### TECHNICAL FIELD

The disclosure relates to an electrode assembly of a lithium secondary battery, and in particular it relates to the structure and composition of a separator thereof.

### BACKGROUND

When an internal short-circuit occurs in a conventional lithium battery, much heat is released in a short period of time, such that a polyolefin separator of the battery may melt and become deformed. If the local heat accumulation is not insulated or the internal short-circuit is not terminated, the active material in the lithium battery may decompose to form high-pressure gas. Therefore, the gas will cause an explosion. Accordingly, international lithium battery factories invest a large amount of time and effort to solve the safety problems of an internal short-circuit occurring in the lithium battery. The Japanese company Panasonic disclosed a heat-resistance layer (HRL) utilized in a lithium battery. The mechanical strength of the separator is enhanced to avoid internal short-circuits (e.g. positive electrode directly contacting the negative electrode) from occurring, improving battery safety. However, the heat-resistance layer is composed of a high amount of inorganic particles (e.g. Al₂O₃) and a low amount of an organic polymer binder, thereby increasing the internal impedance of the lithium battery. In addition, the inorganic particles are easily peeled, losing their protective effect when being used.

Accordingly, a novel separator with a lower impedance than that of a conventional battery (containing a heat-resistance layer), while not affecting safety, is still called-for.

### SUMMARY

One embodiment of the disclosure provides a separator, comprising: a porous polyolefin layer; and a nano fiber web on the porous polyolefin layer, wherein the nano fiber web includes a plurality of nano fibers interwoven with each other.

One embodiment of the disclosure provides an electrode assembly of a lithium secondary battery, comprising: an anode plate; a cathode plate; and the described separator for conducting lithium ions of an electrolyte and separating the anode plate and the cathode plate.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1-3 show electrode assemblies of a lithium secondary battery in embodiments of the disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

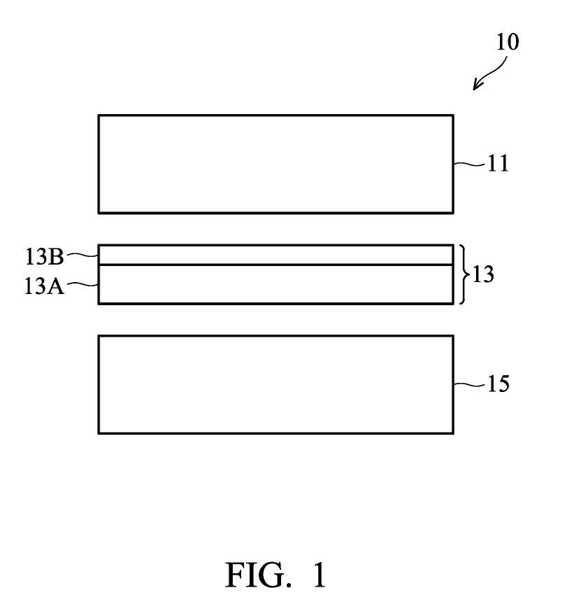

As shown in FIG. 1, the electrode assembly 10 of a lithium secondary battery includes an anode plate 11, a separator 13, and a cathode plate 15. The anode plate 11 can be a layered composition of a current collecting material such as copper foil or nickel foil, and electrode active material particles such as natural graphite, artificial graphite, lithium metal, or lithium alloy. The electrode active material particles have a particle diameter of about 5 μm to 25 μm. If the electrode active material particles are too large, the cell capacitance will largely differ to reduce the average capacitance. If the electrode active material particles are too small, the charge/discharge cycle lifetime of the cell will be shortened and the cell capacitance difference will be increased.

The cathode plate 15 can be a layered composition of a current collecting material such as aluminum foil, and electrode active material particles such as lithium cobaltate, lithium manganate, lithium nickelate, lithium vanadate, or lithium nickel cobalt manganese oxide. The electrode active material particles have a particle diameter of about 1 μm to 40 μm. If the electrode active material particles are too large, the cell capacitance will largely differ to reduce the average capacitance. If the electrode active material particles are too small, the charge/discharge cycle lifetime of the cell will be shortened and the cell capacitance difference will be increased.

The separator 13 may conduct the lithium ions of the electrolyte and separate the anode plate 11 and the cathode plate 15. In one embodiment, the separator 13 includes a porous polyolefin layer 13A and a nano fiber net 13B thereon. The porous polyolefin layer 13A can be polyethylene, polypropylene, a copolymer thereof, or a multi-layered structure thereof. The porous polyolefin layer 13A should have a porosity of about 40% to 95%. A porous polyolefin layer 13A with an overly high porosity may dramatically contract the size of the separator 13 at high temperatures, such that an internal short-circuit of a cell may occur. A porous polyolefin layer 13A with an overly low porosity will obstruct the lithium ion conduction and therefore increase the internal impedance of the cell. The porous polyolefin layer 13A has a weight average molecular weight of about 1000,000 to 5,000,000. A porous polyolefin layer 13A with an overly low weight average molecular weight cannot efficiently separate the anode and cathode due to insufficient mechanical strength of the separator 13. A porous polyolefin layer 13A with an overly high weight average molecular weight cannot be efficiently melted and closed to terminate lithium ions conduction when the cell temperature is increased.

In one embodiment, the porous polyolefin layer 13A has a thickness of about 0.1 μm to 25 μm. An overly thin porous polyolefin layer 13A easily causes an internal short-circuit due to insufficient mechanical strength of the separator. An overly thick porous polyolefin layer 13A will reduce the volumetric energy density of the cell and increase the internal impedance of the cell. In one embodiment, the porous polyolefin layer 13A has a pore size of 1 nm to 0.34 μm. A porous polyolefin layer 13A with an overly large pore size may dramatically contract the size of the separator 13 at high temperatures, such that an internal short-circuit of a cell may occur. The porous olefin layer is composed of polyolefin such as polypropylene (PP) or polyethylene (PE), which has a thermal resistant temperature less than 130° C. and easily contract. As such, the abnormal high temperature of the cell may contract the porous polyolefin layer. A porous polyolefin layer 13A with an overly small pore size will obstruct the lithium ion conduction and therefore increase the internal impedance of the cell. Both of small pore size and low porosity will increase the internal impedance.

The nano fiber net 13B is formed by a plurality of nano fibers interwoven with each other. Note that if the material of the nano fiber net 13B (e.g. polyimide) is directly shaped as a film and then adhered to the porous polyolefin layer, the separator will have an overly low porosity and an overly small pore size. Because the adhering step needs an adhesive for complete adherence, the adhesive may flow into the pores of the porous polyolefin layer and block its pores. The nano fiber net 13B may enhance the thermal resistance of the separator 13, and its fibrous structure may increase the anti-punch property and the size stability of the separator 13. In addition, the nano fiber net 13B may increase the porosity of the separator 13 and curved wound path of ions in the separator, thereby enhancing the ionic conductivity of the separator 13. In one embodiment, the nano fiber net 13B has a thickness of 0.5 to 10 and a pore size of 10 nm to 300 nm. An overly thick nano fiber net 13B may have an overly small pore size to increase the impedance. An overly thin nano fiber net 13B has an insufficient thermal resistance (e.g. size stability at high temperature). A nano fiber net 13B with an overly small pore size will increase the impedance. A nano fiber net 13B with an overly large pore size has a low porosity. In one embodiment, the nano fibers of the nano fiber net 13B has a diameter of 10 nm to 500 nm. Nano fibers with an overly large diameter may make the nano fiber net have an overly large pore size. Nano fibers with an overly small diameter may make the nano fiber net have an overly small pore size.

In one embodiment, the nano fiber net 13b is formed directly on the porous polyolefin layer 13A by electrospinning. For example, a suitable polymer solution can be conducted to a nozzle connected to a high voltage, so that the polymer solution will be attracted by electrostatic force under the electric field to form nano fibers. The high voltage is between about 25 kV to 30 kV. An overly low high voltage will form fibers with an overly large diameter. An overly high voltage will form fibers with an overly small diameter. In some embodiments, the nozzle includes a gas outlet to assist and accelerate the polymer solution injected out of the nozzle. After the polymer solution is injected out of the nozzle, the solvent thereof is volatized. As such, the polymer is dispersed to multiple nano fibers. The nano fibers are interwoven with each other to form the nano fiber net 13B on the porous polyolefin layer 13A.

In one embodiment, the nano fiber net 13B is composed of nano fibers including polyimide (PI), which is polymerized of diamine and dianhydride. For efficiently adhering the nano fibers on the porous polyolefin layer 13A, at least one of the diamine and the dianhydride is aliphatic or cycloaliphatic. In one embodiment, the diamine is aromatic diamine, and the dianhydride is aliphatic or cycloaliphatic dianhydride. In another embodiment, the diamine is aliphatic or cycloaliphatic diamine, and the dianhydride is aromatic dianhydride. In a further embodiment, the diamine is aliphatic or cycloaliphatic diamine, and the dianhydride is aliphatic or cycloaliphatic dianhydride. Note that if both of the diamine and the dianhydride are aromatic, the nano fiber net 13B composed of the polyimide and the porous polyolefin layer 13A can be easily delaminated due to insufficient adherence therebetween.

For example, the aliphatic diamine can be

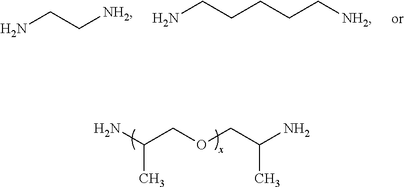

(x is 2 to 70), and the cycloaliphatic diamine can be

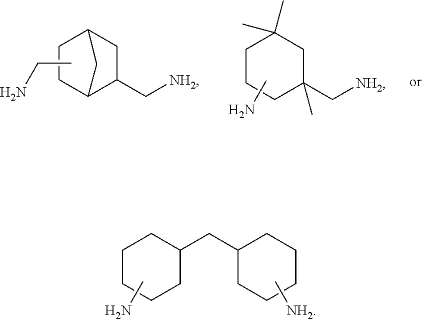

On the other hand, the cycloaliphatic dianhydride can be

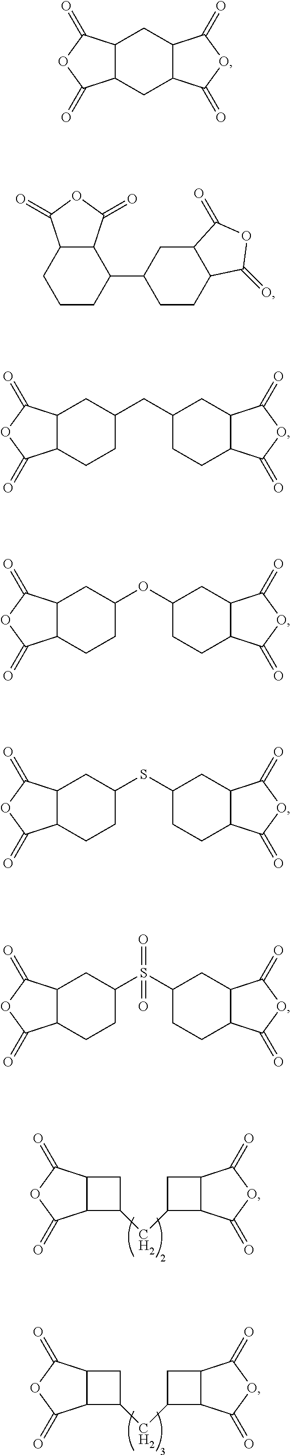

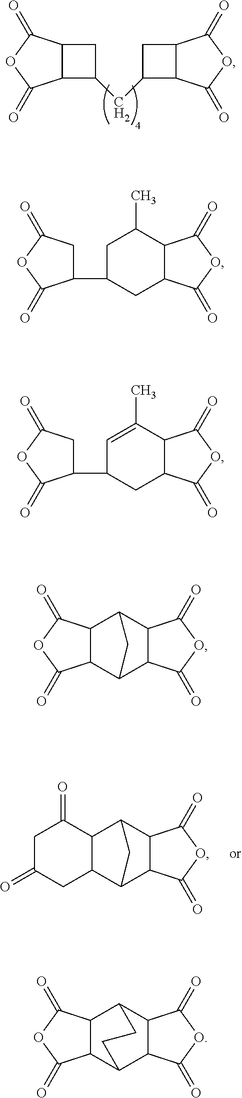

In one embodiment, the polyimide has a weight average molecular weight of 10000 to 100000. A polyimide with an overly low weight average molecular weight has a poor ropiness. A polyimide with an overly high weight average molecular weight is too viscous to be processed and has a poor storage property.

In one embodiment, the nano fibers not only include polyimide but also polyvinylidene difluoride (PVDF), polyacrylonitrile (PAN), or a combination thereof to increase the adherence between the nano fiber net 13B and the porous polyolefin layer 13A. In this embodiment, the polyimide and the PVDF, PAN, or a combination thereof, have a weight ratio of 1:0.1 to 1:5. An overly low amount of the PVDF, PAN, or a combination thereof is similar to the nano fibers without the PVDF, PAN, or a combination thereof, which cannot further increase the adherence between the nano fiber net 13B and the porous polyolefin layer 13A. An overly high amount of the PVDF, PAN, or a combination thereof will lower the thermal resistance of the separator 13.

In one embodiment, the nano fiber contains more than 0 wt % and less than or equal to 50 wt % of inorganic material such as silica or alumina to further increase the thermal resistance of the separator 13. The nano fibers cannot be continuously shaped with an overly high amount of the inorganic material.

In one embodiment, the porous polyolefin layer 13A and the nano fiber net 13B of the separator 13 have a basis weight ratio of 1:1 to 1:0.1. A separator 13 with an overly high ratio of the porous polyolefin layer 13B has an insufficient thermal resistance. A separator 13 with an overly low ratio of the porous polyolefin layer 13B has an insufficient strength.

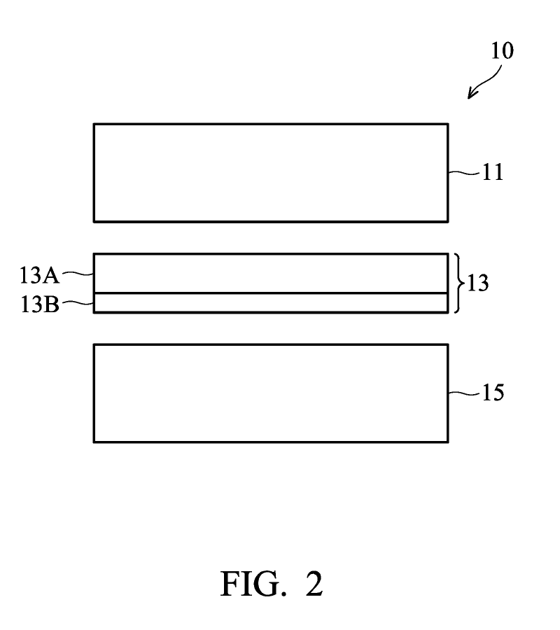

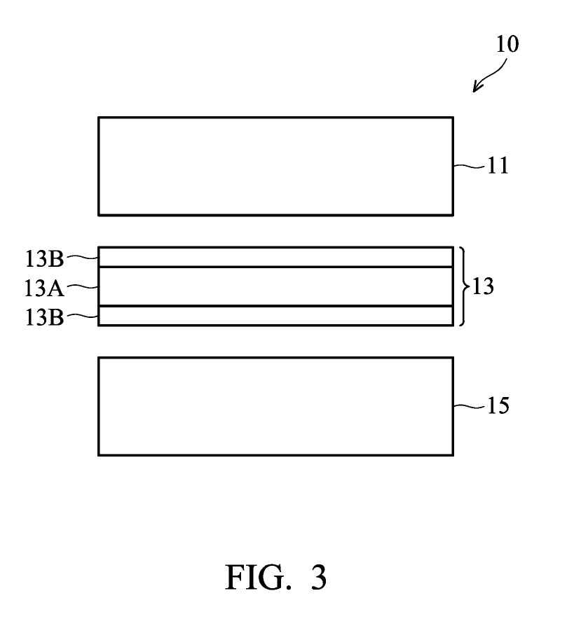

In FIG. 1, the nano fiber net 13B is disposed between the porous polyolefin layer 13A and the anode plate 11. However, the nano fiber net can be disposed between the porous polyolefin layer 13A and the cathode plate 15, as shown in FIG. 2. In addition, the structures in FIGS. 1-2 can be combined as shown in FIG. 3, wherein the nano fiber net layers 13B can be disposed between the porous olefin layer 13A and the anode plate 11 and between the porous olefin layer 13A and the cathode plate 15.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Preparation Example 1

0.0147 g of aromatic diamine and 0.015 mole of cycloaliphatic dianhydride were added into NMP to form a liquid with a solid content of 30%. The liquid was stirred at room temperature for 1 hour to form a viscous polyamic acid solution. The polyamic acid was then heated to 220° C. and reacted at 220° C. for 3 hours to be dehydrated for forming polyimide, and the water from the dehydration reaction was simultaneously removed by a Dean-Stark device. The above reaction is shown in Formula 1, wherein n is a repeating number. The polyimide was diluted by DMAc to form a polyimide solution with a solid content of 20%. The weight average molecular weight of the PI was 51542, which was analyzed by GPC.

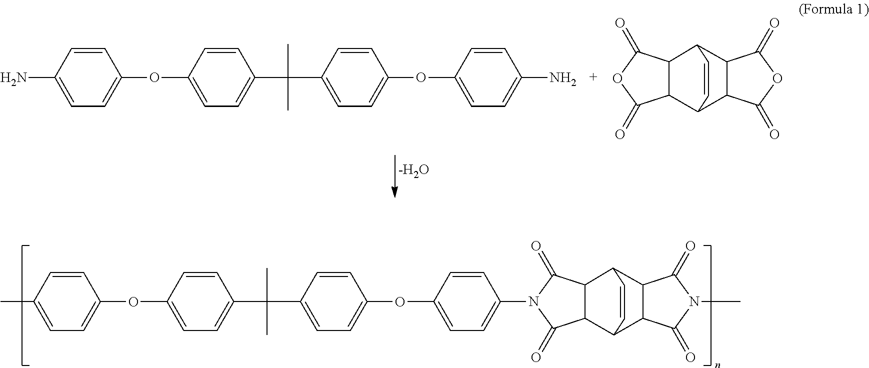

### Example 1

The PI in Preparation Example 1 was electrospun by a voltage of 25 kV to 30 kV to form a nano fiber net on a porous polyethylene layer (Celgard 2320). The porous polyethylene layer had a thickness of 15 μm and a basis weight of 10 g/cm². The nano fiber net had a thickness of 5 μm, a basis weight of 1 g/cm², and a pore size of 100 nm to 200 nm. The nano fibers of the nano fiber net had a diameter of 10 nm to 100 nm. The nano fiber net and the porous polyethylene layer of the separator had a basis weight ratio of 1:10. The separator had a total thickness of 20 μm, a pore size of 30 nm to 50 nm, a porosity of 45% (measured by a method in Journal of Power Sources 266 (2014) 29-35), a McMullin number less than 10 (measured by a method in Journal of Power Sources 266 (2014) 29-35), and a size shrinkage ratio at 200° C. of about 20%.

### Example 2

PVDF (KYNAR761) was added into the PI solution in Preparation Example 1 to form a polymer solution, wherein PI and PVDF had a weight ratio of 2:1. The polymer solution was electrospun by a voltage of 25 kV to 30 kV to form a nano fiber net on a porous polyethylene layer (Celgard 2320). The porous polyethylene layer had a thickness of 15 μm and a basis weight of 10 g/cm². The nano fiber net had a thickness of 5 μm, a basis weight of 1 g/cm², and a pore size of 100 nm to 300 nm. The nano fibers of the nano fiber net had a diameter of 50 nm to 300 nm. The nano fiber net and the porous polyethylene layer of the separator had a basis weight ratio of 1:10. The separator had a total thickness of 20 μm, a pore size of 30 nm to 50 nm, a porosity of 45%, a McMullin number less than 10, and a size shrinkage ratio at 200° C. of about 20%.

### Example 3

PVDF (KYNAR761) was added into the PI solution in Preparation Example 1 to form a polymer solution, wherein PI and PVDF had a weight ratio of 1:1. The polymer solution was electrospun by a voltage of 25 kV to 30 kV to form a nano fiber net on a porous polyethylene layer (Celgard 2320). The porous polyethylene layer had a thickness of 15 μm and a basis weight of 10 g/cm². The nano fiber net had a thickness of 5 μm, a basis weight of 1 g/cm², and a pore size of 50 nm to 100 nm. The nano fibers of the nano fiber net had a diameter of 10 nm to 100 nm. The nano fiber net and the porous polyethylene layer of the separator had a basis weight ratio of 1:10. The separator had a total thickness of 20 μm, a pore size of 30 nm to 50 nm, a porosity of 45%, a McMullin number less than 10, and a size shrinkage ratio at 200° C. of about 15%.

### Example 4

PVDF (KYNAR761) was added into the PI solution in Preparation Example 1 to form a polymer solution, wherein PI and PVDF had a weight ratio of 2:1. The polymer solution was electrospun by a voltage of 25 kV to 30 kV to form a nano fiber net on a porous polyethylene layer (Celgard 2320). The porous polyethylene layer had a thickness of 15 μm and a basis weight of 10 g/cm². The nano fiber net had a thickness of 8 μm, a basis weight of 4 g/cm², and a pore size of 50 nm to 150 nm. The nano fibers of the nano fiber net had a diameter of 10 nm to 100 nm. The nano fiber net and the porous polyethylene layer of the separator had a basis weight ratio of 4:10. The separator had a total thickness of 23 μm, a pore size of 20 nm to 40 nm, a porosity of 44%, a McMullin number less than 10, and a size shrinkage ratio at 200° C. of about 6%.

### Example 5

PVDF (KYNAR761) was added into the PI solution in Preparation Example 1 to form a polymer solution, wherein PI and PVDF had a weight ratio of 2:1. The polymer solution was electrospun by a voltage of 25 kV to 30 kV to form a nano fiber net on a porous polyethylene layer (Celgard 2320). The porous polyethylene layer had a thickness of 15 μm and a basis weight of 10 g/cm². The nano fiber net had a thickness of 10 μm, a basis weight of 8 g/cm², and a pore size of 100 nm to 200 nm. The nano fibers of the nano fiber net had a diameter of 10 nm to 100 nm. The nano fiber net and the porous polyethylene layer of the separator had a basis weight ratio of 8:10. The separator had a total thickness of 25 μm, a pore size of 20 nm to 40 nm, a porosity of 44%, a McMullin number less than 10, and a size shrinkage ratio at 200° C. of about 4%.

### Example 6

PVDF (KYNAR761) was added into the PI solution in Preparation Example 1 to form a polymer solution, wherein PI and PVDF had a weight ratio of 2:1. SiO₂ was then added into the polymer solution, such that the polymer solution contained 20 wt % of SiO₂. The polymer solution was electrospun by a voltage of 25 kV to 30 kV to form a nano fiber net on a porous polyethylene layer (Celgard 2320). The porous polyethylene layer had a thickness of 15 μm and a basis weight of 10 g/cm². The nano fiber net had a thickness of 10 μm, a basis weight of 5 g/cm², and a pore size of 80 nm to 170 nm. The nano fibers of the nano fiber net had a diameter of 10 nm to 100 nm. The nano fiber net and the porous polyethylene layer of the separator had a basis weight ratio of 5:10. The separator had a total thickness of 25 μm, a pore size of 10 nm to 30 nm, a porosity of 44%, a McMullin number less than 10, and a size shrinkage ratio at 200° C. of about 4%.

### Example 7

PVDF (KYNAR761) was added into the PI solution in Preparation Example 1 to form a polymer solution, wherein PI and PVDF had a weight ratio of 2:1. SiO₂ was then added into the polymer solution, such that the polymer solution contained 50 wt % of SiO₂. The polymer solution was electrospun by a voltage of 25 kV to 30 kV to form a nano fiber net on a porous polyethylene layer (Celgard 2320). The porous polyethylene layer had a thickness of 15 μm and a basis weight of 10 g/cm². The nano fiber net had a thickness of 10 μm, a basis weight of 5 g/cm², and a pore size of 100 nm to 200 nm. The nano fibers of the nano fiber net had a diameter of 30 nm to 120 nm. The nano fiber net and the porous polyethylene layer of the separator had a basis weight ratio of 5:10. The separator had a total thickness of 25 μm, a pore size of 10 nm to 30 nm, a porosity of 45%, a McMullin number less than 10, and a size shrinkage ratio at 200° C. of about 2%.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A separator, comprising:
a porous polyolefin layer; and
a nano fiber web on the porous polyolefin layer,
wherein the nano fiber web includes a plurality of nano fibers interwoven with each other.

2. The separator as claimed in claim 1, wherein the polyolefin layer comprises polyethylene, polypropylene, a copolymer thereof, or a multi-layered structure thereof.

3. The separator as claimed in claim 1, wherein the porous polyolefin layer has a thickness of 0.1 μm to 25 μm and a pore size of 10 nm to 300 nm.

4. The separator as claimed in claim 1, wherein the nano fiber web has a thickness of 0.5 μm to 10 μm and a pore size of 10 nm to 300 nm.

5. The separator as claimed in claim 1, wherein the nano fibers have a diameter of 10 nm to 500 nm.

6. The separator as claimed in claim 1, wherein the nano fibers include polyimide polymerized of diamine and dianhydride, wherein at least one of the diamine and the dianhydride is aliphatic or cycloaliphatic.

7. The separator as claimed in claim 6, wherein the polyimide has a weight average molecular weight of 10000 to 100000.

8. The separator as claimed in claim 6, wherein the nano fibers further include polyvinylidene difluoride, polyacrylonitrile, or a combination thereof, and the polyimide and the polyvinylidene difluoride, polyacrylonitrile, or a combination thereof have a weight ratio of 1:0 to 1:10.

9. The separator as claimed in claim 1, wherein the nano fibers further comprise more than 0 wt % and less than or equal to 50 wt % of inorganic material.

10. The separator as claimed in claim 1, wherein the porous polyolefin layer and the nano fiber web have a basis weight ratio of 1:0.1 to 1:2.

11. An electrode assembly of a lithium secondary battery, comprising:
an anode plate;
a cathode plate; and
the separator as claimed in claim 1 for conducting lithium ions of an electrolyte and separating the anode plate and the cathode plate.
